(19) United States
(12) Patent Application Publication
(10) Pub. No.: US 2021/0166160 A1
(43) Pub. Date: Jun. 3, 2021

(54) System and method for automatic reservation of an athletic facility using a chat bot

(71) Applicant: Fitstarter LLC, Moscow (RU)

(72) Inventors: Nikolay Vadimovich Ptitsyn, Moscow (RU); Alexey Dmitrievich Shmakov, Yekaterinburg (RU); Dmitry Alexandrovich Mikitich, Mozyr (BY)

(21) Appl. No.: 15/779,209

(22) PCT Filed: Apr. 14, 2018
(86) PCT No.: PCT/RU2018/000266

§ 371 Date: May 25, 2018

(30) Foreign Application Priority Data
Mar. 12, 2018 (EA) 201800189

(51) Int. Cl. G06Q 10/02; H04L 12/58; G06F 16/9032; G06F 16/9035; G06F 16/908; G06F 16/909

(52) U.S. Cl. CPC G06Q 10/02; H04L 51/02; H04L 51/046; G06F 16/909; G06F 16/9035; G06F 16/908; G06F 16/90324

(57) ABSTRACT

A method for automatic reservation of an athletic facility using a chat bot includes registering athletic facilities and users in a database, and assigning a unique ID to each athletic facility and user; receiving parameters of a search query from a user via a chat session between the user and a chat bot, where query contains a preferred location for reservation of an athletic facility; searching for available time slots for reservation of at least one athletic facility corresponding to at least one search parameter; matching a partner who corresponds to at least one search parameter from the system database; communicating information athletic facilities and available time slots for reservation to the user, via the chat session; receiving confirmation of reservation; and notifying the user about the result of reservation of an athletic facility, via the chat session.

### FIELD OF THE INVENTION

The present invention relates to digital data processing that is used with chat bots, and, more particularly, to use of chat bots to search for and automatically reserve/rent athletic facilities, order sports-related services, search for sports partners or coaches, or organize tournaments.

### DESCRIPTION OF THE RELATED ART

Currently, an increasing number of companies is striving to automate their client servicing and maintenance costs. This is why chat bots and other AI-based programs have become more popular than ever. Whereas total automation of client servicing is probably impossible, making at least some portions of that process automated would considerably decrease labor costs. Therefore, currently, chat bots are one of the most popular investment venues.

Many companies that are oriented to providing quality services are eager to introduce chat bots into their daily operations, but they don't know how to implement them. Chat bots may help service providers to promptly react at client requests, thus saving on labor costs while also providing a welcome and personalized experience to the clients.

Currently, there are conventional solutions that offer certain functions to service providers, where chat bots have been successfully integrated to dramatically improve client-company interactions.

Such solutions include chat bots in restaurants and retail shops, the chat bots greeting the clients and offering them menu items, just like an assistant at the cashier's desk: they offer the customer an option to make an order, pay for it, and notify the customer when it will be ready. Chat bots can not only take away some of the workload from the restaurant staff, but also improve the client's experience.

### Chat Bots and Tourism

For hotel owners, automation is a way to solve many problems related to performance, workforce costs, and sequencing of production processes within a large system. Quick and precise delivery of information to clients is an important success factor in any business, especially in one as price-conscious and highly competitive as the tourism and hospitality industry. Chat bots are useful to hotels in a variety of spheres, from time management to lowering costs for quality servicing. Chat bots assist hotel guests with the simplest issues, while the hotel staff is free to address more urgent or difficult problems.

### Chat Bots and Healthcare

Healthcare chat bots include HealthTap, Amazon's Alexa and icliniq. Chat bots are more suitable than autonomous applications for interaction with patients. The users will be able to ask health-related questions and receive immediate answers from the database. The chat bot anonymity may be useful in certain situations, when there is no need to involve a human doctor. Chat bots simplify access to the healthcare system and also allow to provide clients with personalized health tips.

### Chat Bots and News

News and media companies, such as The Wall Street Journal, CNN, Fox News and others, have launched their own chat bots in Facebook Messenger, so that their readers and viewers could stay updated with the latest news and events in real time.

### Chat Bots and E-Trading

In e-trading, mobile messengers and chat bots can open new sales channels using the Internet. The future of e-trading is for every brand to have their own chat bots that interact with their clients via proprietary applications, Facebook Messenger or other messaging applications.

### Chat Bots and the Fashion Industry

Chat bots, artificial intelligence and machine learning create new opportunities for the fashion industry, from detailed data analysis to chat bots acting as personal stylists. With the Internet catching up with traditional shopping in popularity, the clients are getting a simple experience, which is also a non-human one. This specific issue can be solved with chat bots. Clients may interact with bots that are capable of exchanging messages, offer the required articles and information. Leading fashion brands, such as Burberry and Tommy Hilfiger, have recently launched their own chat bots for the London and New York Fashion Weeks. The leading cosmetics brand Sephora and clothings brand H&M have also launched their chat bots in Kik.

### Chat Bots and Finance

Chat bots have also penetrated the finance industry. Such boths may be programmed to assist clients as financial advisors, or to keep an eye on spendings, accounts, taxes, etc. Banks have broad capabilities to develop their own bots in order to cut costs and also to decrease the human factor in information processing. Chat bots may also benefit the clients by controlling multiple accounts and directly checking their balance and spendings.

### Chat Bots and the Fitness Industry

Chat-based fitness startups, such as FitCircle, have also launched their chat bots in Facebook Messenger in order to provide their clients with personalized tips on how to stay healthy and fit. Technological fitness companies get an enormous competitive advantage by developing their own chat bots and providing their vast clientele with personalized services.

Companies across various industries create chat bots in popular messaging applications, such as Slack, Facebook Messenger, Kik, etc., as well as in their own applications and web sites.

The drawbacks of the conventional solutions include limited functionality, specifically, inability to analyze and automatically find reservation options based on search parameters provided by the user, as well as to automatically reserve athletic facilities for family members, sparring partners, and coaches.

The major drawback of the conventional solutions is that it is impossible to reserve an athletic facility directly from a group chat with partners and coaches, or with a voice assistant. Thus, users have to utilize additional applications or web services, and then notify their partners about the reservation or changes in its status.

### SUMMARY OF THE INVENTION

The present invention relates to a new service providing a wide variety of functions related to selection and reservation of athletic facilities for various kinds of sports trainings or games, based on selection criteria.

An object of the invention is to expand functionality of such systems and methods by providing for automatic reservation of athletic facilities using a chat bot. Users can rent an athletic facility or order a sports service directly from their messengers, particularly, from a group chat between participants of a sports training or a game, or via their voice assistants, without the need to install additional applications.

In a preferred embodiment of the present invention, there is provided a method for automatic reservation of an athletic facility using a chat bot, the method including registering athletic facilities and users in a database of a system for reservation of athletic facilities, and assigning a unique ID to each athletic facility and user; receiving parameters of a search query from at least one user via a chat session between the user and a chat bot, wherein the query contains at least a preferred location for reservation of an athletic facility; searching for available time slots for reservation of at least one athletic facility corresponding to at least one search parameter; matching at least one partner, that corresponds to at least one search parameter, from the system database; communicating information on one or more athletic facilities and available time slots for reservation to the user, via at least one chat session with the chat bot; receiving confirmation of reservation of an athletic facility from at least one user, via at least one chat session with the chat bot; and notifying users about the result of reservation of an athletic facility, via at least one chat session with the chat bot.

The object is also achieved by a system for automatic reservation of an athletic facility using a chat bot, the system including user devices and a system for reservation of athletic facilities with a database, where the user devices are configured to apply for registration of a user in the database of the system for reservation of athletic facilities; to send search queries containing at least a preferred location for reservation of an athletic facility, via a chat session between a user and a chat bot; where the system for reservation of athletic facilities is configured to register athletic facilities and users in the database, and assign a unique ID to each athletic facility and user; to receive a search query from at least one user via a chat session between the user and a chat bot, where the query contains at least a preferred location for reservation of an athletic facility, for available time slots for reservation of at least one athletic facility corresponding to at least one search parameter; to match at least one partner, that corresponds to at least one search parameter, from the database; to communicate information on one or more athletic facilities and available time slots for reservation to the user, via at least one chat session with the chat bot; to receive confirmation of reservation of an athletic facility from at least one user, via at least one chat session with the chat bot; and to notify users about the result of reservation of an athletic facility, via at least one chat session with the chat bot.

In an illustrative embodiment, a unique ID (UID) of an athletic facility is generated based on at least one data type, selected from the following: name, organization number, license number, geographical address, Internet address, e-mail address, phone number, chat channel (chat bot) ID of the athletic facility.

In another illustrative embodiment, a unique ID (UID) of a user is generated based on at least one data type, selected from the following: user name, e-mail address, cell phone number, or messenger ID.

In another illustrative embodiment, search parameters include any of a time slot (date and time), location data, skill level, user rating, a sport, equipment type, training type, sports technique type, sex, age, or a combination thereof. The user rating may be determined based on ratings given by other users. There may also be separate ratings for sparring partners, coaches, trainees, judges.

In another illustrative embodiment, for each time slot for reservation of an athletic facility, its parameters are determined, which are selected from the following: date of the visit, time of the visit, training/game duration, reservation price, any special offers, promotions or discounts, rented equipment type, reservation cancellation rules, coach services, partner ID, or a combination thereof.

In another illustrative embodiment, to match at least one partner, their location is used.

In another illustrative embodiment, to match at least one partner, the history of joint trainings or games is used.

In another illustrative embodiment, to match at least one partner, the user's address book is used.

The user IDs are obtained from the address book on the user's mobile device to be used as search parameters.

In another illustrative embodiment, to match at least one partner, the skill level of the first user is used and/or the partner's rating, as assigned by other users. The user may input the skill value explicitly into their search query. If the user has provided their skill level in their profile, the profile data may be used to search for partners of a matching level.

In another illustrative embodiment, to match at least one partner, their availability for the given reservation time slot is used. The availability of a partner may be determined using following methods: by sending a request to the partner via a chat session; by checking their schedule for the given time slot; by comparing the time slot with personal settings of the partner.

In another illustrative embodiment, to match at least one partner, their search and/or reservation history is used. To do this, a search parameter of the user's search query is compared to a corresponding paramter in the search or reservation history of the given partner. Thus, it is possible to find partners who prefer training in the specified sports club, in the specified city, and in the specified time slot.

In another illustrative embodiment, the user creates a group chat session with potential partners, and to match at least one partner, IDs of other users in the group chat session are used. For instance, there may be a joint chat session for a couch, a trainee, and a chat bot, that is used to schedule and reserve training sessions. On a request by the coach or the trainee, the chat bot may reserve an athletic facility, while partner matching is based on the ID of another user in the given chat session.

In another illustrative embodiment, the chat bot automatically creates a group chat session between the user and/or their partners to receive reservation confirmations and payments, and to send notifications.

In another illustrative embodiment, reservation notifications for user devices are generated using the chat bot.

In another illustrative embodiment, a chat session with the chat bot is initiated in an information channel, such as Telegram, WhatsApp, Slack, Skype, Viber, Facebook Messenger or voice assistants.

In another illustrative embodiment, location data is any of country, city, neighborhood, street, city block, or a combination thereof.

In another illustrative embodiment, at least one type of location data is determined using a GPS navigation system. GPS data of a user device may be sent to the user either automatically via the chat session, or on the chat bot's request.

In another illustrative embodiment, the location data are selected from the user's reservation history.

In another illustrative embodiment, the location data is selected from the user's profile.

In another illustrative embodiment, the chat bot supports any of the following message types: text, photo, video, GPS coordinates, contacts, inline buttons, payment details, voice stream, voice mails, and stickers. These message types may provide a more detailed information about athletic facilities, sparring partners, and coaches, assisting the user in making the right choice of an athletic facility and a partner in the reservation process. A video message may contain a recording of training process or a game, which was made during the reservation process, or a random video demonstrating the skill level of a user. A message containing GPS coordinates may be used as a search parameter to look for athletic facilities of partners who are closest to the user. A message containing contacts may be used to provide the contact details of a potential partner or an athletic facility representative to the user. A message may contain buttons, so that the user would have to type less text. For instance, instead of typing their decision, the user may click OK or CANCEL or SELECT. A message with payment information may contain credit card data or information on other means of payment. Voice messages may be used to replace text messages, particularly, when a voice assistant is used. Stickers may be used to visually represent facilities and partners who have been found.

In another illustrative embodiment, an athletic facility is selected from the following types of facilities: tennis courts, volleyball venues, basketball venues, beach volleyball venues, badminton courts, soccer fields.

In another illustrative embodiment, interaction with users is carried out via a web interface and/or mobile application. In another illustrative embodiment, to search for available athletic facilities and/or users, information about previous athletic facility reservations of the user is used.

In another illustrative embodiment, to search for available athletic facilities and/or users, sports skills of the users are used. The user may provide their skill level at the registration stage, the level may be further confirmed by ratings given by their partners. Also, the user skill level may be defined automatically, based on skill levels of their partners. When searching for an athletic facility, the average skill level of users visiting this facility may be taken into account.

In another illustrative embodiment, to search for available athletic facilities and/or users, artificial intelligence algorithms are used. For instance, an artificial intelligence (AI) may be based on a convolutional neural network capable of deep learning. Reservation parameters, such as the city, partners' sex, age, skill, and preferred time slots are provided as input of the neural network. The output forms a user's descriptor, which can then be used for personalized search, or to rank/filter search results by calculating the similarity value between the descriptor of the user conducting the search and other users that have been found. The results will be ranked either by increasing similarity, or by descreasing a distance between the descriptors. Also, these descriptors may be used to cluster athletic facilities and/or users in order to make the search more effective or to make personalized recommendations and offers. The probability of a successful reservation or a degree of mutual interest in joint trainings between two users is evaluated at the output of the neural network. Also, the neural network is capable of classifying athletic facilities and/or users based on various features in order to increase search efficiency. For instance, the neural network is capable of automatically determining the rating of an athletic facility or a user. The output of the neural network may be used to rank and/or filter search results listing athletic facilities and/or users. The neural network is trained with actual reservation and partner matching data.

In another illustrative embodiment, to search for available athletic facilities and/or users, statistical algorithms are used. First, features of athletic facilities and/or partners are extracted that have significant correlation for all reservations. For instance, when choosing an athletic facility, the user may look for specific equipment type or rating; and when choosing a partner, the user may look for specific gender, skill level or age. For each user making a search, the system calculates mean values of the extracted features of athletic facilities and/or partners that reflect their preferences. In addition to mean values, other known statistical values, such as standard deviation, may be used. Then, the system searches through athletic facilities and/or partners in accordance with the user's query. For each athletic facility and/or partner that have been found, the system evaluates the degree of similarity between their features and mean values that have been calculated for the given user. The degree of similarity may be calculated based on standard metrics. Also, reverse metrics, such as the Euclidean distance (metric), may be used. The search results are ranked by the degree of similarity, e.g., by decreasing distance. After ranking, the results are displayed to the user in the chat session. Thus, the user will get personalized recommendations conforming to their skill level.

In another illustrative embodiment, to search for available athletic facilities and/or users, faceted classification is used. The chat bot allows to refine or expand search queries by adding or disabling faceted filters, correspondingly. To do this, the chat bot may ask follow-up questions or make suggestions on adding or disabling certain filters. In another illustrative embodiment, to search for available athletic facilities and/or users, correlation algorithms are used. The correlation is calculated between parameters of athletic facilities previously reserved by the user and those of athletic facilities that are being searched through, e.g., sports equipment type and athletic facility rating. In the same fashion, the correlation is calculated between parameters of the user making a reservation and those of other users (potential partners), e.g., their skill level and age. The resulting correlation values may be used to rank athletic facilities and/or users in the search results.

In another illustrative embodiment, the chat bot is integrated into instant messaging services, such as Telegram, WhatsApp, Slack, Skype, Viber, Facebook Messenger, or voice assistants. The chat bot is integrated into an instant messaging service via the application programming interface (API) or the software development kit (SDK) of the given service. The chat bot may also be integrated into any application on a personal user device, as well as into a standard messenger.

In another illustrative embodiment, the chat bot is configured to find and show images of athletic facilities and sports equipment, as well as pictures of users, sparring partners and coaches, etc.

In another illustrative embodiment, at least one user pays for the reserved athletic facility via the chat session.

In another illustrative embodiment, at least one user receives a message through the hcat session regarding the accessibility of an athletic facility and/or a potential partner based previously-defined search criteria. For example, the user can pre-select an athletic facility, so that the system automatically notifies the user regarding any reservation options, including any discounts or special offers. After receiving the notification, the user can then find a partner and make the reservation based on the special offer.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE ATTACHED FIGURES

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows an exemplary embodiment of the system for automatic reservation of an athletic facility using a chat bot.

FIG. 2 shows an exemplary data structure in the service for automatic reservation of athletic facilities.

FIG. 3 shows an exemplary algorithm of the service for automatic reservation of athletic facilities.

FIG. 4 shows an exemplary chat session for reservation of an athletic facility.

FIG. 5 shows an exemplary interface of the athletic facility administrator.

FIG. 6 shows an exemplary embodiment of a computing device or server that may be used in the invention.

### DETAILED DESCRIPTION OF THE PREFERRED EMBODIMENTS

Reference will now be made in detail to the preferred embodiments of the present invention, examples of which are illustrated in the accompanying drawings.

An athletic facility is a property or a property complex, including athletic venues, specifically designed to hold sports events.

Some illustrative athletic facilities, which are not limiting the scope of the invention, may be a race track, a skating rink, a swimming pool, a velodrome (bicycle race track), a sports hall, a tennis court, a volleyball venue, a basketball venue, a beach volleyball venue, a badminton court, a soccer field, a shooting range, etc.

The present invention allows not only to rent an athletic facility, but also order coaching services and rent sports equipment.

According to the present invention, users are registered in the database of the system for automatic reservation of athletic facilities using their user devices and/or by the athletic facility administrator.

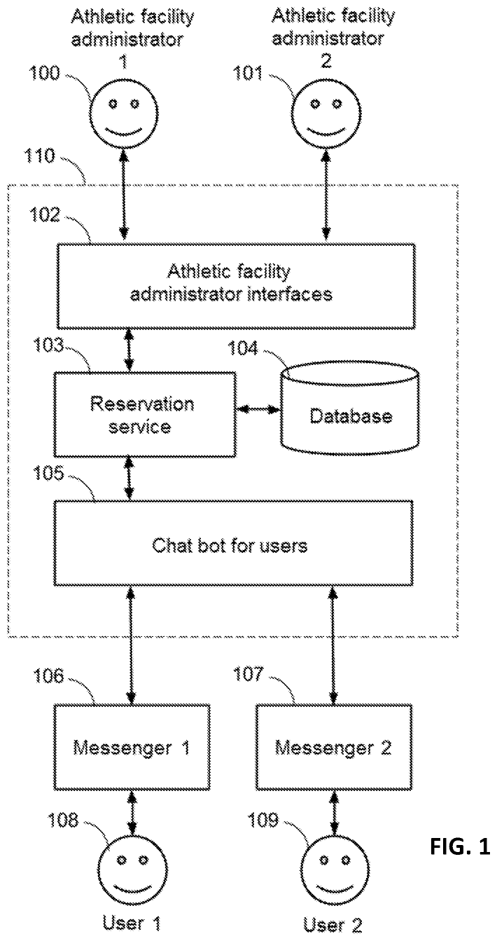

FIG. 1 shows an exemplary embodiment of the system for automatic reservation of an athletic facility using a chat bot. A service for reservation of athletic facilities 110 includes a service core 103, a database 104, a chat bot 105, and an administrator interface 102. The core 103 of the service for reservation of athletic facilities processes the data of users, athletic facilities, schedules, reservations, and stores them in the database 104. At one end, athletic facility administrators 100 and 101 are connected to the reservation service 103 via the administrator interfaces 105 to input data on the availability of athletic facilities for reservation.

At the other end, users 108 and 109 are connected to the reservation service via messengers 106 and 107 and the chat bot 105 for users.

The chat bot 105 is connected to the messengers 106 and 107 either directly or via instant messaging services 106 and 107. The components above interact with each other via an API of the messaging services or using corresponding protocols.

The reservation service 110 may be implemented as software on a cloud, virtual or dedicated server connected to user devices via communication channels. For instance, the athletic facility reservation service may be implemented on Google Cloud or Amazon EC2. To protect personal data of users, standard data protection means may be utilized, such as communication channel encryption, user authorization with login and password, temporary passwords, firewalls, or security monitoring systems.

The reservation service may be integrated into other services for user interaction without the need to install additional applications, e.g., into such services as instant messaging services, messengers (WhatsApp or Telegram), social networks (Facebook or VKontakte).

The users 108 and 109 make search queries and athletic facility reservations using conventional input/output devices (I/O devices) of the user device that are capable of recognizing commands, translate them into a machine-readable format, and then display information to the user. Such devices may include, but are not limited to, keyboards, sensor screens, displays, monitors, speakers, microphones, projectors, remote controls, mouses, joysticks, trackballs, touchpads, styluses, etc.

A user device may be any computing device capable of establishing network connection to other computing devices. For instance, computing devices include a smartphone, a talbet, a desktop computer, a laptop, a gaming console, a Smart-TV set, a voice assistant, a robot, a Smart House system, a self-service terminal in a sports club, etc.

The user device has software installed that provides for interaction with the chat bot 105, such as software of the messenger 106 and 107, a social network, voice assistant, etc.

Network communication may be implemented via a data exchange computer network, such as the Internet.

A database 104, where data about users and athletic facilities is stored, may be implemented as a ready-made database management system, such as NoSQL (e.g., MangoDB or Cassandra), or it may be implemented as a relational database (e.g., MySQL or PostrgeSQL)—in case the database does not have to undergo any significant scaling.

First, the users 108 and 109 are registered in the database 104 of the athletic facility reservation service 103, wherein the users are each assigned a unique ID (UID). Such UIDs include, but are not limited to: user name, e-mail address, cell phone number, or messenger ID. Certain messengers, such as Telegram, cannot send user mobile phone number over the API to protect personal data. So, in order to identify such users, an alternative messenger ID can be used, represented by a random sequence of symbols.

Users may be registered, when the join the reservation chat bot by installing the bot into the user's messaging application. Also, they may register on the reservation service web site, or they may be registered by the athletic facility administrator. The registration process may be automated by using deep links, which may contain the user registration data, such as phone number, name, and usual athletic facility, in coded format.

Athletic facilities are registered in the reservation system itself, specifically, in its database. Athletic facility data, including their locations, opening hours, sports equimpent types, and service types, may be provided by the athletic facility administrator 100 and 101 via the administrator interface 102 that is connected to the reservation service core 103. Besides, athletic facility data may be imported from external databases or mapping services.

The database may also store additional information that is necessary for the reservation, such as competition bracket, completed competitions (e.g., those confirming users' skill levels), sports school schedules, coach schedules, weather reports, etc. The additional information may be imported from third-party information systems using APIs and SDKs. For example, competition brackets or finished competition data that are used to prove users' skill levels, or training schedules, may be imported from the information system of a sports federation or a sports school, while a weather forecast may be imported from an Internet provider to bring a better user experience when booking outdoor facilities.

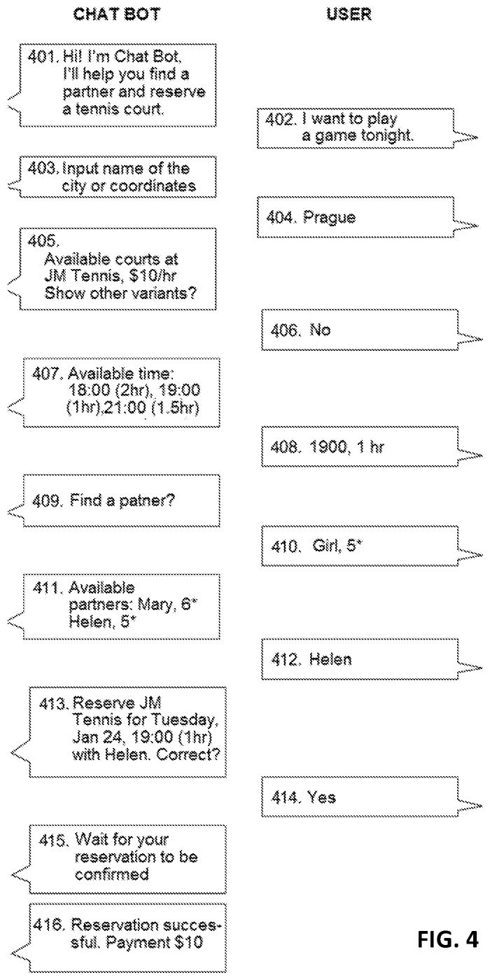

The athletic facility administrator interface 102 may be implemented as a web interface, as shown in FIG. 4. The administrator interface may also include a reservation calendar, a reservation list, a user list, a pass list, some financial information, rates, and other settings for an athletic facility. Alternatively, the administrator interface may be implemented as a downloadable application for a mobile device or a desktop computer, or as a chat bot. The administrator interface may be also configured to integrate with the software used to manage athletic facilities, such as 1C Fitness or MindBody.

Each athletic facility is assigned its UID that is generated based on at least one data type from the following: name, organization number, license number, geographical address, Internet address, e-mail address, phone number, chat channel (chat bot) ID of the athletic facility.

After the user has been registered, they may send search queries via a chat session with a chat bot. The chat session with a chat bot 105 is initiated via an information channel. Such channels can include, for example, Telegram, WhatsApp, Slack, Skype, Viber, Facebook Messenger or voice assistants. The voice assistants can include, for example, Google Now, Siri, Amazon Alexa, Microsoft Cortana, Alisa, and Dusya.

The main purpose of the chat bot 105 is to assist users in making an automatic reservation and to quickly process popular requests connected to upcoming trainings or games. The chat bot 105 may be implemented as a special application, or based on a platform for Natural Language Processing (NLP), aka Natural Language Understanding (NLU), such as Google's DialogFlow, Amazon's Wit.ai, or IBM's Watson. The chat bot 105 may be also based on a conventional chat bot service, such as ManyChat, ChatFuel, etc. Multiple chat bots 105 may be simultaneously connected to the reservation service core 103 in order to accommodate users from different geographical or language areas.

The chat bot can also notify users regarding upcoming reservations, inform them regarding new reservation options of the athletic facilities, new potential partners, special offers or discounts based on pre-defined search parameters. The user can confirm the reservation by answering the notification in the current chat session.

The user may interact with the chat bot 103 in different languages, wherein the chat bot is capable of determining the user's language automatically, or take into account the language settings of the user's messenger that are transmitted over the API.

Search parameters can include, for example, a time slot (date and time), location data, skill level, a sport, equipment type, training type, sports technique type, gender, age, or a combination thereof. The user may request a specific time, date and/or time slot for their reservation. In addition, the user may also request a specific number of partners for a joint training or a game.

To match at least one partner, the skill level of the first user, as well as their availability for the given reservation time slot and/or date, or their previous joint games or trainings is used. Also, partner matching may be carried out based on similar search queries initiated by other users (partners), or their locations, or a sports competition bracket.

As an option, the partners may be selected based on ranking the potential partners based on some criteria, e.g., geographic proximity of the potential partner, his/her rating, which one of several potential partners confirms first, or randomly or pseudorandomly, given a selected location.

The chat bot searches for at least one athletic facility corresponding to at least one search parameter. Athletic facilities can include, for example, tennis courts, volleyball venues, basketball venues, beach volleyball venues, badminton courts, and soccer fields.

At the same time, for each athletic facility, some parameters are defined, that are selected from the following: date of the visit, time of the visit, training/game duration, reservation price, rented equipment type, reservation cancellation rules, coach services, partner ID, or a combination thereof.

To search for athletic facilities, the information about the user's previous reservations can be used.

The location of a given athletic facility may be either inputted manually by the athletic facility administrator, or imported from a mapping system, such as Google Maps or Yandex.Maps.

The preferred location for a training or a game in the search query may be provided by the user using text or voice, e.g., by inputting the name of the country, city, neighborhood, street, sports club, or a combination thereof.

The preferred location for a training or a game in the search query may also be provided by the user using GPS systems, including GLONASS, Wi-Fi, or GPS services provided by mobile operators. The user may send GPS coordinates through the messenger.

When an athletic facility conforming to the search parameters has been found, the information about one or more variants is sent to the user by the chat bot via one or more chat sessions. Also, the chat bot may find pictures of the athletic facilities and/or sports equipment, and send them to the user.

An athletic facility will be automatically reserved as soon as the athletic facility reservation service receives a reservation confirmation from the user device. After that, the athletic facility is automatically reserved via at least one chat session with the chat bot. The result of reservation is communicated to at least one user. Then, at least one user pays for the reserved athletic facility via the chat session. Moreover, the chat bot notifies the users about their reservation and the upcoming training/game.

To search for athletic facilities and/or partners for training or game, AI algorithms and/or statistical algorithms are used. Such algorithms allow to analyze habits of a given user and provide targeted notifications in due time.

In addition to search and reservation, the chat bot is capable of moving, xtending, or cancelling a reservation.

Search parameters may be provided by the user when they create a search query in the chat session, or the parameters may be acquired automatically from other sources. For instance, search parameters may be acquired from the following sources: user profile (e.g., age, sex, skill level), previous search queries, reservation history (e.g., ID of a health club the user has already visited, or profiles of partners the user has associated with), user geolocation and/or language settings (e.g., country or city), or from a deep link followed by the user.

The reservation service can generate deep links, following which the user may initiate new chat sessions with the chat bot or invite the chat bot into on-going sessions, e.g. to inform a group of users about the reservation status or changes in the corresponding group reservation. A deep link may contain the reservation ID, user IDs, the chat session ID, or the athletic facility ID.

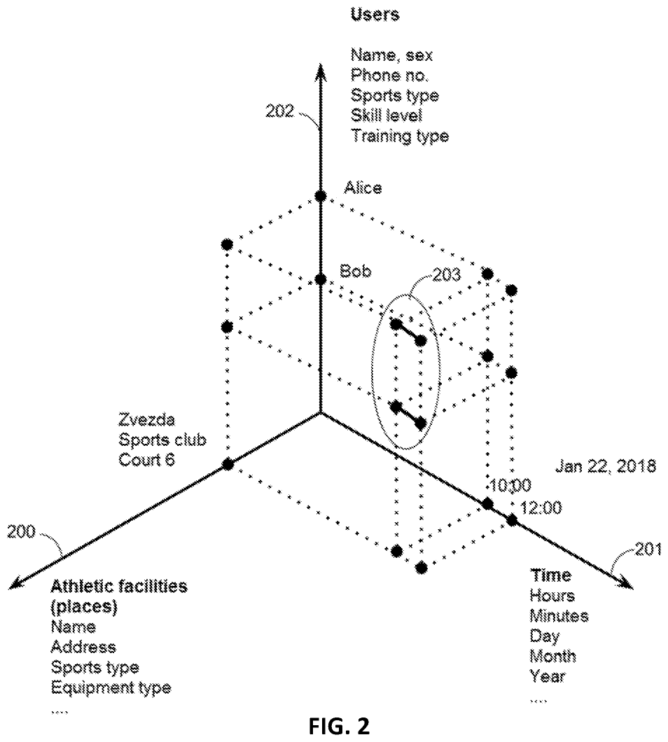

FIG. 2 shows an exemplary data structure in the service for automatic reservation of athletic facilities. The structure has three dimensions: locations 200, time 201, and users 202.

The locations 200 dimension is discrete and comprises a plurality of registered athletic facilities and/or individual components thereof, such as courts or individual sports halls. The locations may have characteristic features, such as the name of the sports club, its address, sports type, service level, equipment type.

Another dimension—time 201—is used to determine time slots for reservation. Time is measured in years, months, days, hourse and/or minutes. The time 201 dimension may be either continuous or discrete.

The users 202 dimension is discrete and comprises a plurality of registered users. Users may have characteristic features, such as, name, phone number, sports type, sex, age, skill level, rating.

For illustrative purposes, FIG. 2 shows two sections 203 that correspond to reservations of the “Zvezda” athletic facility, court 6, for 10 AM-12 PM, Jan. 22, 2018, made by two users: Bob and Alice. Each individual section 203 corresponds to the reservation made by a single user, and its length reflects the rent duration of the athletic facility.

Athletic facilities and time slots, that are available for reservation using the chat bot, may be presented as sections in the present data structure, along with support information, which is necessary for reservation, including reservation rates, discounts, and cancellation rules.

The data structure, as shown in FIG. 2, may be stored in the database 104 and then used to search for athletic facilities available for reservation, or users for joint trainings.

The data search in the storage may be based on faceted classification to enable faceted search, also called faceted navigation or faceted browsing of sport facilities, service offers or partners. Faceted search allows users to explore a collection of information by applying multiple filters such as city, timeframe, partner skill level and age. The advantage of faceted search is that it allows to refine the search query by limiting the number of available filters. The chat bot allows the user to refine the search query by adding faceted filters, wherein the set of such additional filters is basically limited to available athletic facilities, services and/or partners. For instance, if the user has specified a sports club in the search parameters, then the chat bot can suggest filtering time slots by time of the day or day of the week, which would correspond to time slots that are actually available. On the other hand, the chat bot allows the user to expand their queries by disabling faceted filters. If the search query returns no results, the chat bot may automatically disable one or more filters.

To do this, the chat bot may send corresponding suggestions to the chat session, e.g., complemented with tips and buttons allowing the user to quickly apply or disable filters.

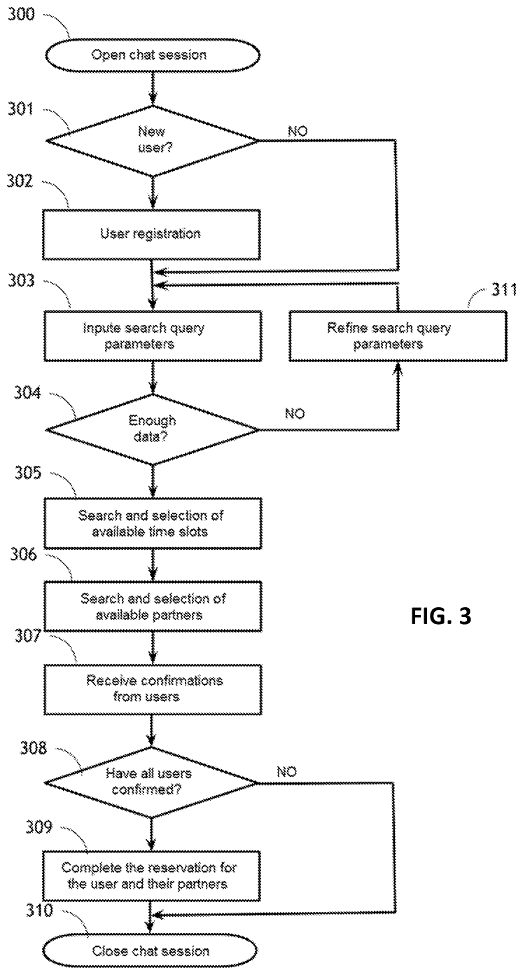

FIG. 3 shows an exemplary algorithm of the service for automatic reservation of athletic facilities. First, a chat session with a user is opened (step 300). Then, the algorithm check if this is a new user (step 301). If the user is not registered (step 302), i.e. has an unknown ID, they are registered (step 303). Next, a search query with search parameters is received (step 304). If these parameters are not enough (step 305), e.g., the user selected a location but not a reservation date, then the search parameters are refined (step 311). Then, reservation time slots are searched and selected (step 305). Partners for a joint training are searched and matched (step 306). A reservation confirmation is received from one user or all users (step 307). If all users confirm the selection (step 308), then the selected athletic facility becomes reserved for the selected time slot with the selected partner (step 309). The chat session is closed (step 310).

FIG. 4 shows an exemplary chat session between the user and the chat bot for reservation of an athletic facility or matching a partner. The chat bot produces a greeting 401. The user inputs a reservation request providing the preferred time 402. The chat bot asks to refine the request by providing the location of the athletic facility 403. The user inputs the name of the city 404. The chat bot shows the best offer in the city and suggests continuing the search 405. The user refuses to continue the search and selects the suggested athletic facility 406. The chat bot shows the time slots available for reservation 407. The user selects the time slot 408. The chat bot suggests searching for a partner 409. The user inputs search parameters to search for a partner 410. The chat bot shows a list of potential partners 411. The user selects one or several partners from the list 412. The chat bot shows main parameters of the reservation and asks for a confirmation 413. The user confirms the reservation 414. The chat bot receives confirmations from the partners and initiates the reservation process 415. The chat bot notifies the user that the reservation is successful 415.

This illustrative chat session may be implemented in a text-based, a voice-based and/or a video interface. In a text-based interface, the user sends and receives information in text format. In a voice-based interface, the user interacts with the chat bot in natural language. In a video interface, the chat bot synthesizes a video “avatar” that simulates visualized human actions accompanying synthesized speech.

Potential partners may be added to the chat session between the user and the chat bot either automatically or manually.

As an option, searching for partner can be done based on the potential partner's automatically calculated competitive level, his/her rating or a “pyramid” that ranks players based on results of competitions, friendly matches and the like. For example, rating systems such Elo or Glicko-2 can be used to rate the potential partners. Competition results or ratings can also be entered by the various users through the chat session. The reservation system can automatically calculate the ratings for the users and update them as needed, and display the updated ratings in the chat session. The rating of a user can be derived based on rating of other users who participate in the same competitions, for example, using a 5-point scale.

In this illustrative example, the user is searching for an athletic facility and a time slot first. However, the reservation process may be performed in any order. For instance, the user may look for a partner first, and only then search for a time slot for reservation that would accommodate all the participants.

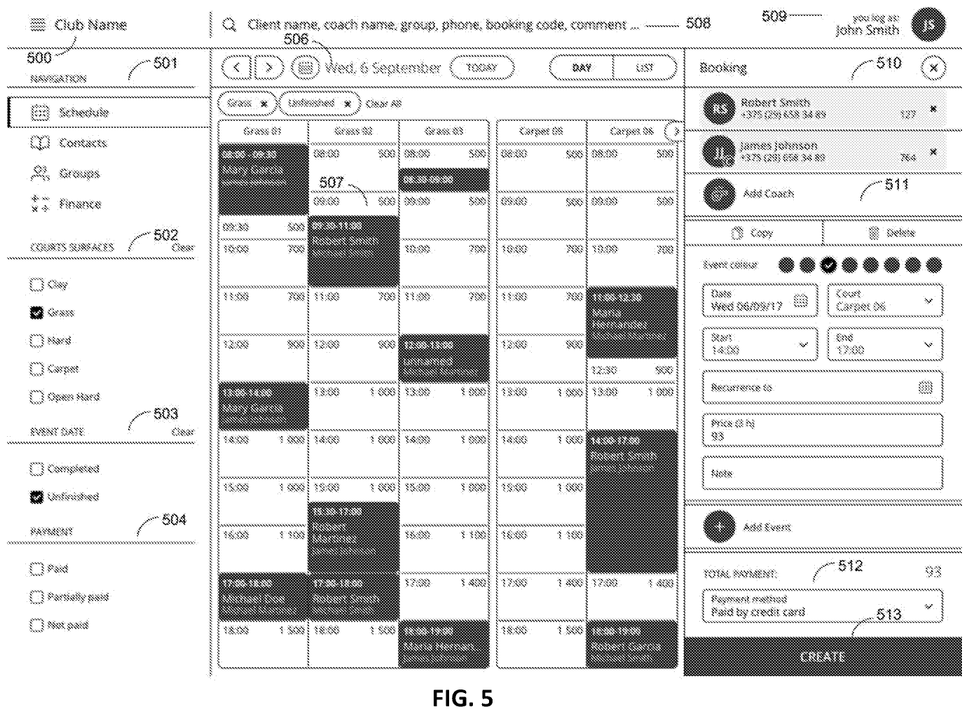

FIG. 5 shows an exemplary interface of the athletic facility administrator, specifically a tennis club. The proposed interface includes the following components: an athletic facility name 500; administering section selection 501; a facet for tennis court group selection 502; facet for reserved event group selection 503; a facet for reserved event payment status selection 504; a facet for reserved event type selection 505; a date selection to show the reservation calendar 506; a string for reserved event search request 507; a reserved event in the calendar 508; a logged-in administrator name 509; a name of the client making a reservation 510; a double/delete selection 511; reservation parameters: date, time, duration, court number, payment status 512; a reservation creation/save button 513.

The proposed interface allows the administrator to manage reservations, created both using a chat bot and manually by the administrator themselves. If the athletic facility has an electronic schedule, it makes it possible for users to find available time slots using a chat bot.

The present invention allows to reduce hardware requirements for the reservation system. On the user side, through a chat bot and partner matching functions, it obviates the necessity to install additional applications, cutting requirements to ROM and RAM. On the server side, by creating a unified infrastructure for a plurality of athletic facilities, it cuts the necessary quantity of servers, memory volumes and CPUs thereof. The present invention allows to avoid maintaining individual servers for each individual athletic facility. Instead, a single or a few servers manage a plurality of athletic facilities.

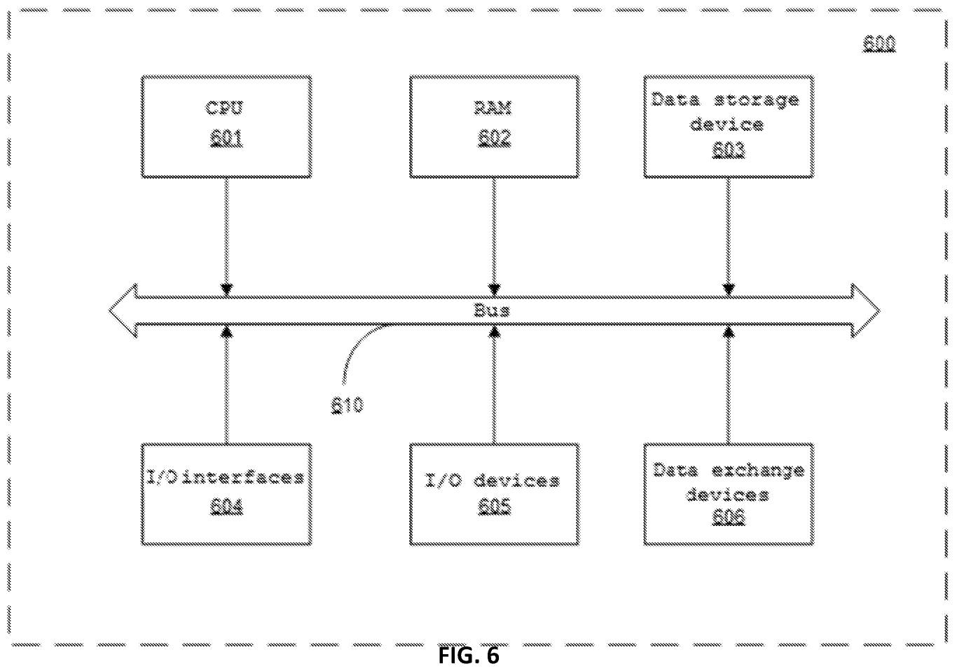

FIG. 6 shows an exemplary embodiment of the computing device 600 that performs the functions according to the method for automatic reservation of athletic facilities using a chat bot, and other functions, through alhorithm-based data processing. The proposed computing device may be implemented on any of the server side, the user (client) side, or the athletic facility administrator side.

Generally, such device 600 comprises the following components: one or more CPUs 601, at least one memory unit 602, a data storage device 603, I/O interfaces 604, an I/O device 605, a network interaction device 606. The CPU 601 performs all basic computations, that are necessary for the system 600 or one or more of its components to function. The CPU 601 performs all necessary machine-readable instructions contained in RAM 602. Generally, the memory unit 602 is Random Access Memory (RAM) that includes program logic that provides for necessary functions.

The data storage device 603 may be implemented as an HDD, SDD disk, a RAID array, a network storage, a flash memory, an optical data carrier (CD, DVD, MD, Blue-Ray), etc. The device 603 provides for long-term storage of various data, e.g., transaction query processing history (log), user IDs, etc.

The interfaces 604 are conventional means used to connect to the server 600, such as USB, RS232, RJ45, LPT, COM, HDMI, PS/2, Lightning, FireWire, etc. Specific interfaces 604 are chosen based on the actual embodiment of the device 600, which may be implemented as a desktop computer, a mainframe, a server cluster, a thin client, a smartphone, a laptop, etc.

Data I/O devices 605 may include: a keyboard, a joystick, a display (a sensor display), a projector, a touchpad, a mouse, a trackball, a stylus, speakers, a microphone, etc.

Network interaction devices 606 represent devices that provide for receiving and transmitting data over the network, such as Ethernet board, WLAN/Wi-Fi module, Bluetooth module, BLE module, NFC module, IrDa, RFID module, GSM modem, etc. The devices 606 are used for transmitting data between the server 600 and the device 600 over a wired or a wireless data transmission channel, such as WAN, PAN, LAN, Intranet, Internet, WLAN, WMAN, or GSM.

Having thus described a preferred embodiment, it should be apparent to those skilled in the art that certain advantages of the described method and apparatus have been achieved.

It should also be appreciated that various modifications, adaptations, and alternative embodiments thereof may be made within the scope and spirit of the present invention. The invention is further defined by the following claims.

What is claimed is:

1. A method for automatic reservation of an athletic facility using a chat bot, the method comprising:
registering athletic facilities and users in a database, and assigning a unique ID to each athletic facility and user;
receiving parameters of a search query from at least one user via a chat session between the user and a chat bot,
wherein the parameters include a preferred location for reservation of the athletic facility;
searching for available time slots for reservation of the athletic facility corresponding to the parameters;
matching at least one partner from the database, who matches at least one search parameter;
communicating information on one or more athletic facilities and available time slots for reservation to the user, via a chat session in the chat bot;
receiving confirmation of reservation of an athletic facility from the user, via the chat session; and
notifying the user about the result of reservation of an athletic facility, via the chat session.

2. The method of claim 1, wherein a unique ID (UID) of an athletic facility is generated based on any of name, organization number, license number, geographical address, Internet address, e-mail address, phone number, and chat channel (chat bot) ID of the athletic facility.

3. The method of claim 1, wherein a unique ID (UID) of a user is generated based on any of user name, e-mail address, cell phone number, and messenger ID.

4. The method of claim 1, wherein the search parameters further include any of a time slot (date and time), location data, skill level, user rating, a sport, equipment type, training type, sports technique type, gender and age.

5. The method of claim 1, wherein for each time slot for reservation of an athletic facility, its parameters are determined, selected from any of date of visit, time of the visit, training/game duration, reservation price, rented equipment type, reservation cancellation rules, coach services, and partner ID.

6. The method of claim 1, wherein the user creates a group chat session with potential partners, and to match at least one partner, IDs of other users in the group chat session are used.

7. The method of claim 1, wherein the chat bot creates a group chat session between the user and/or their partners to receive reservation confirmations and payments, and to send notifications.

8. The method of claim 1, wherein any of the following are used to generate the match with the partner:
the user's address book;
the user's contact list;
a skill level of the user;
the partner's rating;
an availability of a potential partner for the given reservation time slot;
a history of joint training or games;
a list of the user's preferred partners;
a location of the potential partner; and
a search and/or reservation history of the potential partner.

9. The method of claim 1, wherein reservation notifications are generated using the chat bot.

10. The method of claim 1, wherein the location data is any of country, city, neighborhood, city block and street.

11. The method of claim 10, wherein the location data is determined using a GPS navigation system.

12. The method of claim 1, wherein the location data is selected from the user's reservation history.

13. The method of claim 1, wherein the chat bot supports any of text, photo, video, GPS coordinates, voice mails and stickers.

14. The method of claim 1, wherein the chat bot includes a web interface and/or a mobile application.

15. The method of claim 1, wherein (a) sports skills of the potential partners or (b) information about previous athletic facility reservations of the user is used to search for available athletic facilities and/or potential partners.

16. The method of claim 1, wherein artificial intelligence algorithms are used to search for available athletic facilities.

17. The method of claim 1, wherein, correlation algorithms are used to search for available athletic facilities.

18. The method according to claim 1, wherein the chat bot is integrated into any of Telegram, WhatsApp, Slack, Skype, Viber, Facebook Messenger and voice assistants.

19. The method of claim 1, wherein the chat bot is configured to find and show images of any of athletic facilities, sports equipment at the athletic facilities, and user photos.

20. A system for automatic reservation of an athletic facility using a chat bot, the system comprising:
a plurality of user devices in communication with a server-based system for reservation of athletic facilities, the server-based system including a database, wherein the user devices are configured to
(i) apply for registration of a user in the database for reservation of athletic facilities; and
(ii) send search queries containing a preferred location for reservation of an athletic facility, via a chat session between a user and a chat bot;
wherein the server-based system for reservation of athletic facilities is configured to
(i) register athletic facilities and users in the database, and assign a unique ID to each athletic facility and user;
(ii) receive a search query from a user via the chat session b, wherein the query includes a preferred location for reservation of an athletic facility;
(iii) search for available time slots for reservation of an athletic facility corresponding to search parameters;
(iv) match at least one partner from the database, that corresponds to the search parameter;
(v) communicate information on one or more athletic facilities and available time slots for reservation to the user, via the chat session;
(vi) receive confirmation of reservation of an athletic facility from the user via the chat session; and
(vii) notify the user about the result of reservation of the athletic facility, via the chat session.
